(19) United States
(12) Patent Application Publication
(10) Pub. No.: US 2017/0030106 A1
(43) Pub. Date: Feb. 2, 2017

(54) INTERDENTAL COUPLING OF DOOR SPINDLES

(71) Applicant: ELI BRIGA, Kfar Sava (IL)

(72) Inventor: ELI BRIGA, Kfar Sava (IL)

(21) Appl. No.: 14/811,944

(22) Filed: Jul. 29, 2015

(51) Int. Cl. E05B 3/00

(52) U.S. Cl. CPC E05B 3/00

(57) ABSTRACT

A system and method for more effectively securing door knobs to a door spindle in which a toothed door spindle is coupled with a pivoted pawl configured to releasably secure the door knob to the spindle when mounted in a door, the pawl resiliently biased to assume a position within interdental spaces of the spindle.

### BACKGROUND OF THE INVENTION

The present invention relates to door handle and spindle assemblies, and particularly, relates to the long term attachment of door handles or knobs to their spindles. It is known that door knobs are typically fastened to a door spindle with a set screw disposed in the shank of the door knob. This set screw has a propensity to loosen after continued use and may eventually fall out enabling the handle to slip off its spindle when one attempts to open the door. This can be an irritating nuisance compounded further by the loss of the set screw. In other more severe situations, small children can be locked inside a room, panic, and sometimes enter into a state of hysteria when no one responds to their pleas to open the door.

Therefore, there is a need for a more reliable, long-term system and method of fastening door knobs to their spindles.

### SUMMARY OF THE INVENTION

According to the teachings of the present invention there is provided a door assembly including a toothed door spindle; and a pivoted pawl configured to releasably secure a door knob to the toothed door spindle when mounted in a door, the pawl resiliently biased to assume a position within interdental spaces of the spindle.

According to a further feature of the present invention the pivoted pawl is mounted within the door knob.

According to a further feature of the present invention the pivotally mounted pawl is mounted within a knob rose.

According to a further feature of the present invention the toothed spindle is implemented from a metallic material.

There is also provided according to the teachings of the present invention a door assembly including a toothed door spindle mounted in a door; and a pivoted pawl configured to releasably secure a door knob to the toothed door spindle when mounted in a door, the pawl resiliently biased to assume a position within interdental spaces of the spindle.

According to a further feature of the present invention the pivoted pawl is mounted within the door knob.

According to a further feature of the present invention the pivotally mounted pawl is mounted within a knob rose.

There is also provided according to the teachings of the present invention a method for construction a door assembly including mounting a toothed door spindle mounted in a door; and mounting a pivoted pawl configured to releasably secure a door knob to the toothed door spindle when mounted in a door, the pawl resiliently biased to assume a position within interdental spaces of the spindle.

According to a further feature of the present invention the mounting a pivoted pawl is implemented within the door knob.

According to a further feature of the present invention the mounting a pivoted pawl is implemented within the knob rose.

### BRIEF DESCRIPTION OF THE DRAWINGS

The subject matter regarded as the invention is particularly pointed out and distinctly claimed in the concluding portion of the specification. The description of the features, their operation, and advantages may best be understood in reference to the following detailed description and accompanying drawings in which:

FIGS. 1 and 2 are schematic, cross-sectional side views of a door handle and toothed spindle and pawl coupling in engaged and disengaged states, respectively, according to an embodiment;

FIG. 3 is a schematic, cross-sectional side view of a variant embodiment of the door handle and spindle assembly depicted in FIGS. 1 and 2, according to an embodiment;

FIG. 4 is a schematic, cross-sectional side view of a door employing the door handle and spindle assembly depicted in FIGS. 1 and 2 and an additional lock handle and spindle assembly, according to an embodiment; and

FIG. 5 is a schematic, cross-sectional end view of the door knob and spindle assembly depicted in FIG. 4, according to an embodiment.

It will be appreciated that for clarity, depicted elements are not necessarily drawn to scale and reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. Well-known methods, procedures, and components have been omitted for the sake of clarity.

The following terms will be used throughout the document.

“Door assembly” refers to the collective set of accessories relating to securing a door in a closed state or freeing the door to assume an open state.

“Door handle”, “door knob”, “handle”, “door knob” all refer to the part which a user grips when opening or closing a door and are used interchangeably throughout this document.

“Spindle” refers to a toothed shaft or bar that attaches to at least one handle and transferring torque to a latch or lock mechanism when a handles is rotated.

“Pawl” refers to a pivoted pin or lever that engages the spindle when disposed in its interdental spaces, according to an embodiment.

“Knob rose” refers to a base structure covering a spindle bore through the door, according to an embodiment.

“Spindle teeth” refer to the ridges and interdental spaces.

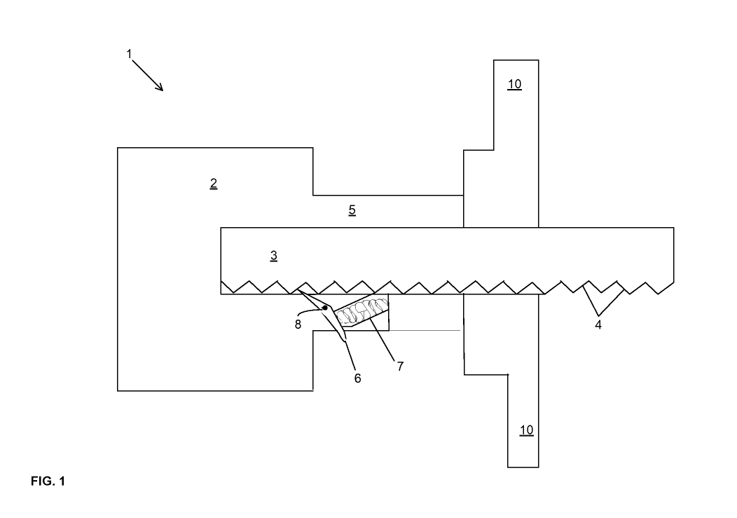

Referring now to the figures, FIGS. 1 and 2 are schematic cross-sectional views of a door assembly 1 including a door knob 2, a door knob shank 5, a toothed spindle 3, a resiliently biased pawl 7 configured to releasably engage spindle 3, and knob rose 10, according to an embodiment.

As shown, knob 2 is securely fastened to spindle 3 by way of pivoted pawl 6 disposed in the interdental spaces 4 of toothed spindle 3 while in an engagement mode. Pawl 6 is pivotally mounted in shank 5 on pin 8 and is biased to assume an engagement position by compression spring 7 also disposed in shank 5, according to an embodiment. Upon application of force “A” pawl 6 pivots around pin 8 and releases spindle 3 so as to enable either removal of knob 2 from spindle 3 as shown by arrow “C” or, alternatively, remove spindle 3 from knob 2.

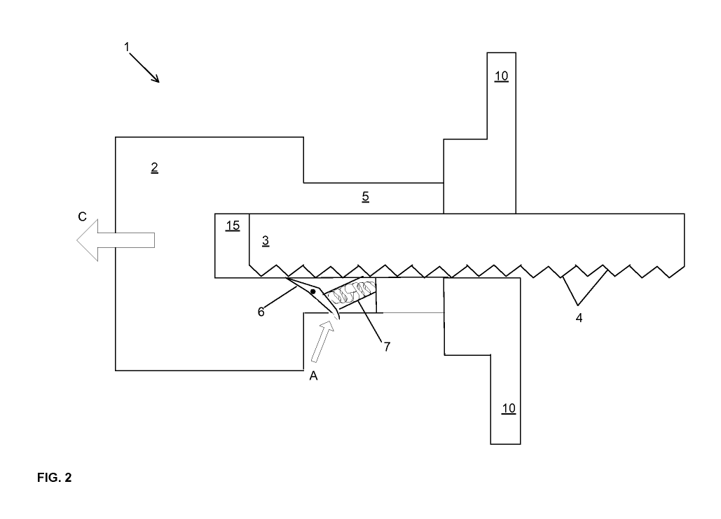

FIG. 3 depicts a variant embodiment of door assembly 1 depicted in FIGS. 1 and 2. This embodiment is implemented with biasing spring 7 and pawl 6 mounted in knob rose 10. It should be appreciated that embodiments in which pawl 6 is pivotally mounted in knob 2 and biasing spring 7 is mounted in knob rose 10, or vice versa, are included within the scope of the present invention. Compression spring 7 is constructed from a flexible metallic material; however, it should be noted that other materials providing such functionality are also included within the scope of the present invention. Furthermore, embodiments employing tension springs or leaf springs or other types of recoil mechanisms providing the required biasing of pawl 6 are included within the scope of the present invention.

In certain embodiments a knob 2 are permanently fastened to spindle 3. In such embodiments, engagement of the knob/spindle unit is achieved by a single spindle/pawl coupling whereas in other embodiments in which each knob is releasably attached to the spindle, two spindle/pawl couplings are required to secure handles 2 to spindle 3. The knob/spindle coupling advantageously provides long-term connection between handle 2 and spindle 3 and eliminates the commonplace complications resulting from a loose or missing set screw as noted above. Furthermore, as depicted, pawl 6 has an accessible contact surface extending from the shank 5 or knob rose 10, thereby facilitating the application of a release force that may be applied by a user without tools.

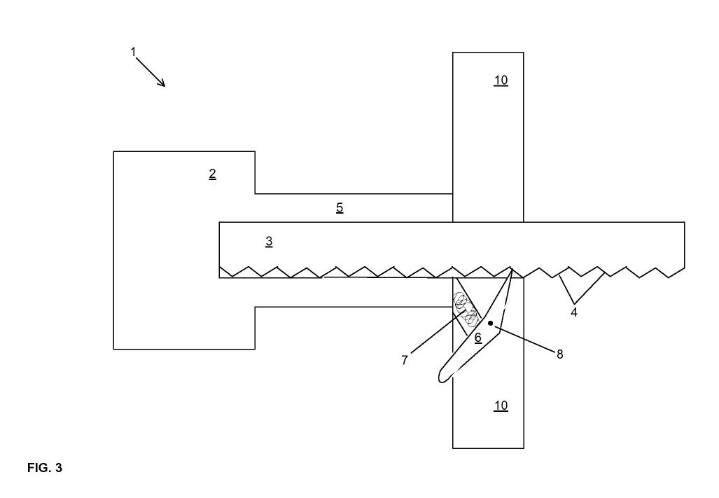

FIG. 4 depicts a door assembly 1 mounted on a door 11; assembly 1 includes two handles 2 connected by toothed spindle 3 traversing both door 11 and latch mechanism 16, and knob roses 10. As shown, pivotally mounted pawl 6 is resiliently biased in an engagement position by compression spring 7. As previously noted, the application of force “A” causes pawl 6 to pivot out of its engagement position, thereby freeing spindle 3 to slide out of knob 2 or alternatively, freeing knob to slide off spindle 3, according to an embodiment.

In a certain embodiment, door 11 also includes a lock assembly 17, handle 22, toothed spindle 13 mounted in the lock handle 22 and lock mechanism 18. Analogously, door lock spindle 13 is secured in lock handle 22 by pawl 16 resiliently biased to engage toothed spindle 13, according to an embodiment.

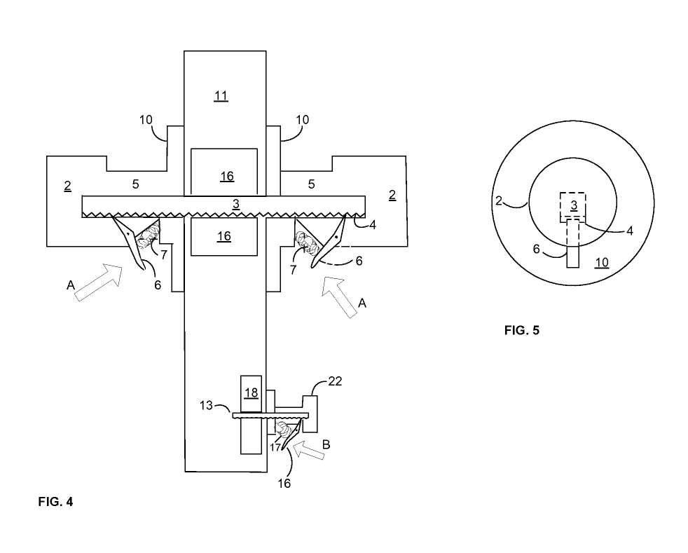

FIG. 5 depicts a schematic end view of the door latch assembly 1 depicted in FIGS. 1-4. Knob 2 and knob rose 10 are implemented as circular structures; but, it should be appreciated that various shapes are included in the scope of the present invention. Further depicted is a toothed spindle 3 and pawl 6 disposed in the interdental space 4 of toothed spindle 3 to such that handle 2 is secured to it as previously noted. It should be further appreciated that spindle 3 embodiments implemented with non-square cross-sections capable of transferring torque to latch mechanisms are included within the scope of the present invention. Spindle teeth 4 are implemented as an alternating series of lateral ridges and grooves in spindle 3 and in certain embodiments span only a fraction of the length of spindle 3 needed to provide the required engagement functionality. Pawl 6 is constructed from a metallic material having sufficient rigidity to secure spindle 3 in place and can withstand the tension applied to knob 2 thought extended use. It should be noted, that various surface geometries of pawl 6 providing the above described engagement functionality are included within the scope of the present invention.

It should be appreciated that various combinations of embodiments not set for the explicitly; but, formed from combinations of features set forth in different embodiments are also included with the scope of the present invention. Furthermore, modifications, substitutions, changes of equivalents are also included within the scope of the present invention.

What is claimed is:

1. A door assembly comprising:
a toothed door spindle; and
a pivoted pawl configured to releasably secure a door knob to the toothed door spindle when mounted in a door, the pawl resiliently biased to assume a position within interdental spaces of the spindle.

2. The assembly of claim 1, wherein the pivoted pawl is mounted within the door knob.

3. The assembly of claim 1, wherein the pivotally mounted pawl is mounted within a knob rose.

4. The assembly of claim 1, wherein the toothed spindle is implemented from a metallic material.

5. A door assembly comprising:
a toothed door spindle mounted in a door; and
a pivoted pawl configured to releasably secure a door knob to the toothed door spindle when mounted in a door, the pawl resiliently biased to assume a position within interdental spaces of the spindle.

6. The assembly of claim 5, wherein the pivoted pawl is mounted within the door knob.

7. The assembly of claim 5, wherein the pivotally mounted pawl is mounted within a knob rose.

8. A method for construction a door assembly comprising:
mounting a toothed door spindle mounted in a door; and
mounting a pivoted pawl configured to releasably secure a door knob to the toothed door spindle when mounted in a door, the pawl resiliently biased to assume a position within interdental spaces of the spindle.

9. The method of claim 8, wherein the mounting a pivoted pawl is implemented within the door knob.

10. The method of claim 8, wherein the mounting a pivoted pawl is implemented within the knob rose.
